(19) United States
(12) Patent Application Publication
(10) Pub. No.: US 2024/0326945 A1
(43) Pub. Date: Oct. 3, 2024

(54) ELECTRIC VEHICLE

(71) Applicant: HONDA MOTOR CO., LTD., Tokyo (JP)

(72) Inventors: Akira Sato, Tokyo (JP); Kazuhiro Suzuki, Tokyo (JP); Yasuo Narazaki, Tokyo (JP)

(21) Appl. No.: 18/601,778

(22) Filed: Mar. 11, 2024

(30) Foreign Application Priority Data
Mar. 31, 2023 (JP) 2023-059263

(51) Int. Cl. B62K 11/04

(52) U.S. Cl. CPC B62K 11/04; B62K 2202/00; B62K 2204/00

(57) ABSTRACT

In an electric vehicle includes: a swing arm swingably supported by a vehicle body through a pivot shaft; a motor arranged in the swing arm and driving a driving wheel; and a functional component of the electric vehicle electrically connected to the motor, a sub frame is provided, the sub frame being separate from a body frame configuring the vehicle body and being attachable to the body frame, the sub frame includes a pivot portion swingably supporting the swing arm, and the functional component of the electric vehicle is supported by the sub frame.

### INCORPORATION BY REFERENCE

The present application claims priority under 35 U.S.C. § 119 to Japanese Patent Application No. 2023-059263 filed on Mar. 31, 2023. The content of the application is incorporated herein by reference in its entirety.

### TECHNICAL FIELD

The present invention relates to an electric vehicle.

### BACKGROUND ART

Conventionally, there has been known an electric vehicle where a driving motor is supported by a swing arm (refer to Patent Literature 1 for example). In Patent Literature 1, there is disclosed a configuration where a PDU (Power Drive Unit) controlling an output of an electric motor that is a functional component of the electric vehicle is supported by the swing arm including the electric motor. According to Patent Literature 1, by disposing the PDU in addition to the electric motor arranged in the swing arm, assembly performance of the swing arm including the functional component of the electric vehicle to a vehicle body is improved.

### CITATION LIST

### Patent Literature

[Patent Literature 1] Japanese Patent No. 5608031

### SUMMARY OF INVENTION

### Technical Problem

However, in Patent Literature 1, since other functional components of the electric vehicle are also supported by the swing arm including the electric motor, there are problems that the swing arm is liable to become large in size and the mass of an unsprung portion that is a swinging portion is liable to increase.

The present invention has been achieved in view of the circumstance described above, and its object is to provide an electric vehicle having excellent assembly performance of a swing arm including a motor and a functional component of the electric vehicle while suppressing the swing arm from becoming large in size and the mass of an unsprung portion from increasing, in the electric vehicle including the swing arm supporting the motor.

### Solution to Problem

An electric vehicle includes: a swing arm swingably supported by a vehicle body through a pivot shaft; a motor arranged in the swing arm and driving a driving wheel; and a functional component of the electric vehicle electrically connected to the motor. In the electric vehicle, a sub frame is provided, the sub frame being separate from a body frame configuring the vehicle body and being attachable to the body frame, the sub frame includes a pivot portion swingably supporting the swing arm, and the functional component of the electric vehicle is supported by the sub frame.

### Advantageous Effects of Invention

In an electric vehicle including a swing arm supporting a motor, it is possible to provide the electric vehicle having excellent performance in assembling the swing arm including the motor and a functional component of the electric vehicle while suppressing the swing arm from becoming large in size and the mass of an unsprung portion from increasing.

### BRIEF DESCRIPTION OF DRAWINGS

FIG. 1 is a left side view of an electric vehicle related to the first embodiment of the present invention.

FIG. 2 is a perspective view of an essential part of the electric vehicle related to the first embodiment of the present invention.

FIG. 3 is a bottom plan view of an essential part of the electric vehicle related to the first embodiment of the present invention.

FIG. 4 is a perspective view as seen from the front left side illustrating the peripheral portion of a sub frame and a PCU related to the first embodiment of the present invention.

FIG. 5 is a rear view illustrating the peripheral portion of the sub frame and the PCU related to the first embodiment of the present invention.

FIG. 6 is a right side view illustrating the peripheral portion of the sub frame and the PCU related to the first embodiment of the present invention.

FIG. 7 is a rear view illustrating the peripheral portion of a sub frame and a PCU related to the second embodiment of the present invention.

FIG. 8 is a perspective view as seen from the front left side illustrating a peripheral portion of a sub frame and a PCU related to the third embodiment of the present invention.

FIG. 9 is a rear view illustrating the peripheral portion of the sub frame and the PCU related to the third embodiment of the present invention.

FIG. 10 is a left side view of an electric vehicle related to the fourth embodiment of the present invention.

### DESCRIPTION OF EMBODIMENTS

Embodiments of the present invention will be hereinafter explained referring to the drawings. Also, in the explanation, description of directions such as front and rear, left and right, and top and bottom is to be same to the direction with respect to the vehicle body unless otherwise described. Also, the sign FR illustrated in each drawing expresses vehicle body forward, the sign UP expresses vehicle body upward, and the sign LH expresses vehicle body left hand.

### First Embodiment

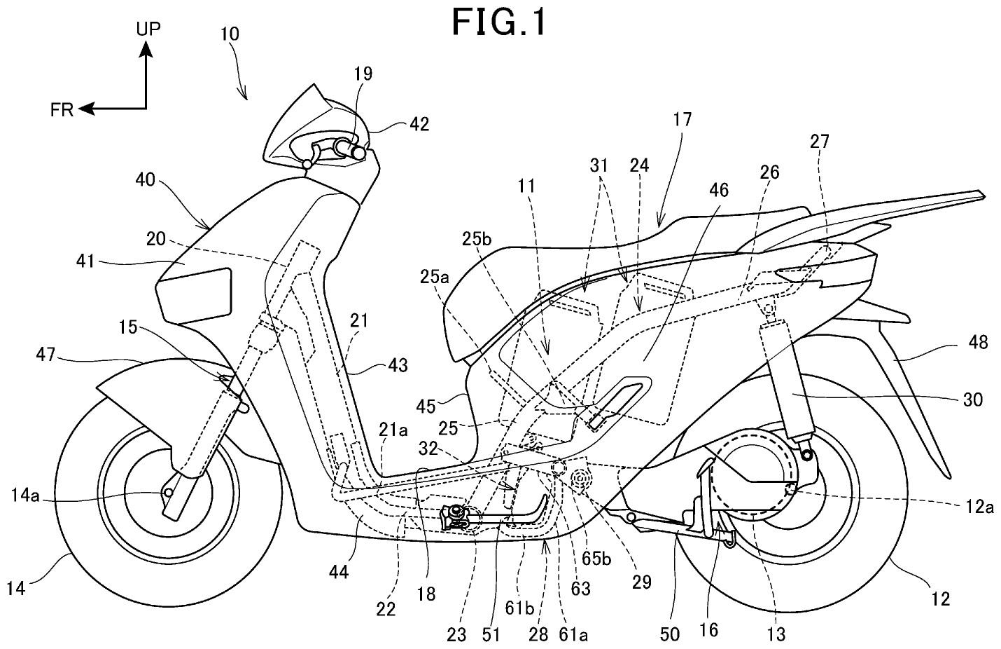

FIG. 1 is a left side view of an electric vehicle 10 related to the first embodiment of the present invention. The electric vehicle 10 is an electromotive motorcycle including a body frame 11, an electric motor (motor) 13 driving a rear wheel 12 that is a driving wheel, a front fork 15 steerably supporting a front wheel 14, a swing arm 16 supporting the rear wheel 12, and a seat 17 for an occupant.

The electric vehicle 10 is a saddle riding vehicle where the occupant saddlingly sits on the seat 17. The electric vehicle 10 of the present embodiment is an electric scooter including a low-slung floor portion 18.

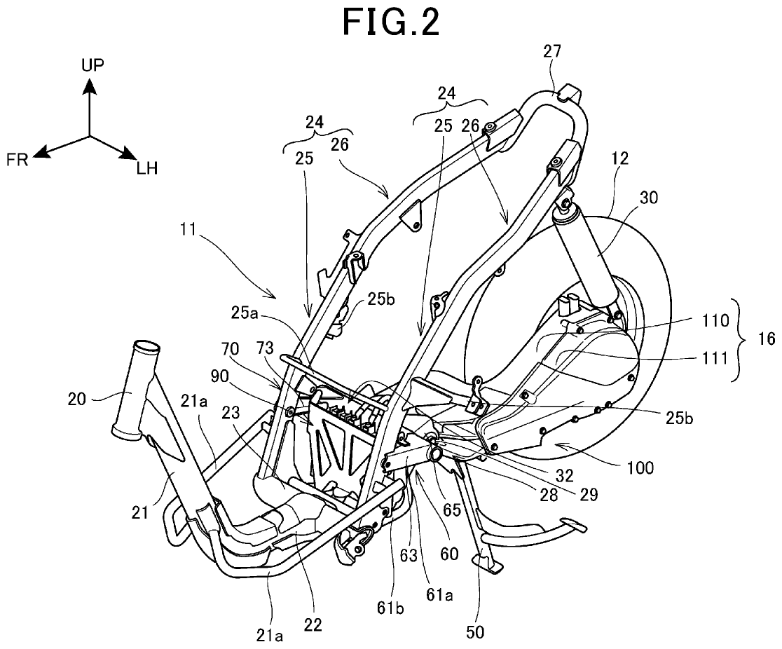

FIG. 2 is a perspective view of an essential part of the electric vehicle 10 related to the first embodiment of the present invention.

The body frame 11 includes a head pipe 20 of the front end portion, a down frame 21 extending obliquely downward to the rear from the head pipe 20, an under frame 22 extending rearward from the lower end of the down frame 21, a cross frame 23 extending in a vehicle width direction from the rear end of the under frame 22, and a pair of left and right side frames 24 extending upward to the rear respectively from the left and right outer ends of the cross frame 23. The side frame 24 includes a rising frame portion 25 extending obliquely upward to the rear from the cross frame 23, and a rear frame portion 26 extending rearward from the rising frame portion 25. The rear ends of a pair of the left and right rear frame portions 26 are connected to each other by a tail pipe 27.

To the lower end portion of the down frame 21, a pair of left and right step frames 21a extending rearward are connected. The step frames 21a are connected respectively to the rising frame portions 25 of the side frames 24. A pair of left and right rising frame portions 25 are connected to each other by a connecting frame 25a connecting the rising frame portions 25 to each other in the front. In the rising frame portion 25, there is arranged a rear step bracket 25b extending outward in the vehicle width direction.

As illustrated in FIG. 1, to the head pipe 20, a pair of the left and right front forks 15 are steerably attached. To the upper portion of the front fork 15, a steering handlebar 19 is attached. To the lower end of the front fork 15, the front wheel 14 is attached through an axle 14a.

To the lower end portion of the left and right side frames 24, a sub frame 28 having a separate shape is attached. A pivot shaft 29 extending in the left and right direction (vehicle width direction) is supported by the sub frame 28.

By the pivot shaft 29, the swing arm 16 extending along the front and rear direction is pivoted. The swing arm 16 extends to the left lateral side of the rear wheel 12 from the pivot shaft 29 (refer to FIG. 2). The rear end portion of the swing arm 16 supports the rear wheel 12 through the axle 12a.

In the swing arm 16, the electric motor 13 is built-in. The electric motor 13 is positioned on the left lateral side of the rear wheel 12. Therefore, the swing arm 16 is configured as a swing type power unit. Between the rear end portion of the swing arm 16 and the rear frame portion 26 on the left side, a rear cushion 30 is connected.

The rear frame portions 26 support the seat 17 from the lower side, the occupant sitting on the seat 17. Below the seat 17, a battery 31 is disposed. The battery 31 is supported by a pair of the left and right side frames 24 and the connecting frame 25a that is positioned in front of the side frames 24.

Below the battery 31, a PCU (Power Control Unit) 32 as an electronic component is supported. The PCU 32 is configured to include an inverter and the like, converts DC power supplied from the battery 31 into AC power for example, and supplies AC power having been converted to the electric motor 13. Also, at the time of regeneration of the electric motor 13, the PCU 32 converts AC power generated by the electric motor 13 into DC power, and recharges the battery 31.

The body frame 11 is covered by a body cover 40.

The body cover 40 includes a front cover 41, a handlebar cover 42, a leg shield 43, a pair of left and right floor side covers 44, an under seat cover 45, a rear side cover 46, and so on.

The front cover 41 covers the front end portion of the body frame 11 such as the head pipe 20 from the front. The handlebar cover 42 covers the center portion in the left and right direction of the steering handlebar 19 above the front cover 41. The leg shield 43 is connected to the rear portion of the front cover 41, and covers the head pipe 20 and the down frame 21 from the rear. The under seat cover 45 covers a space below the seat 17 from the front.

The floor side covers 44 are connected to the leg shield 43 and the under seat cover 45, and cover a pair of the left and right step frames 21a, the under frame 22, and the sub frame 28 from both of the left and right sides. The rear side cover 46 is connected to the rear edge portion of the under seat cover 45, and covers the side frames 24, the battery 31, and so on from both of the left and right sides.

To the front fork 15, there is attached a front fender 47 covering the front wheel 14 from above. Also, to the rear frame portions 26, there is attached a rear fender 48 covering the rear wheel 12 from above.

By the swing arm 16, a main stand 50 is supported.

Also, by the left portion of the cross frame 23, a side stand 51 is supported.

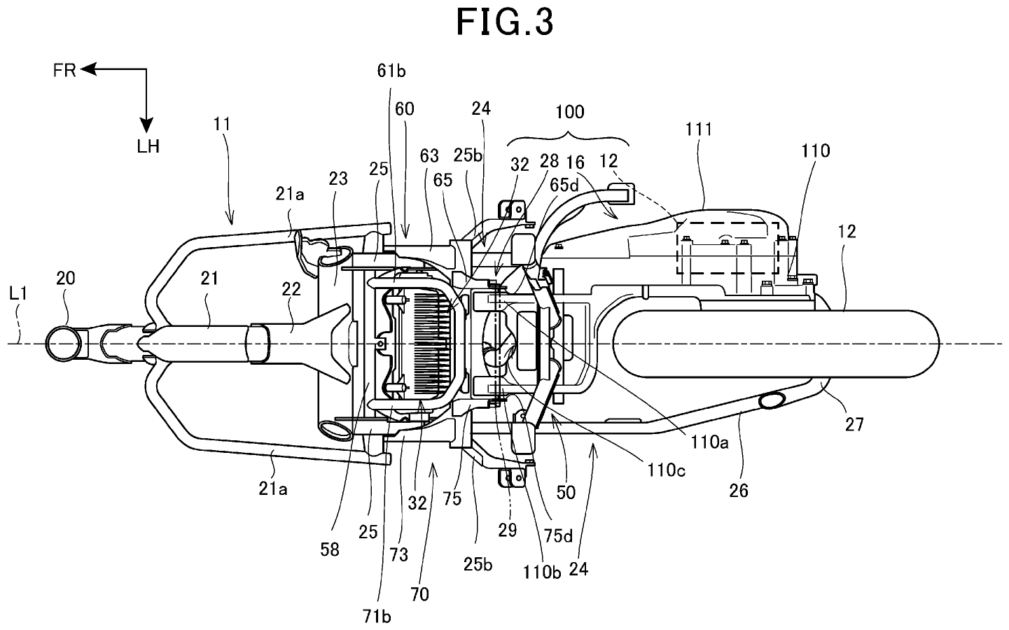

FIG. 3 is a bottom plan view of an essential part of the electric vehicle 10 related to the first embodiment of the present invention.

To the body frame 11, there is attached a swing arm unit 100 including the swing arm 16. The swing arm unit 100 includes the sub frame 28 attached to the body frame 11, the PCU (the functional component of the electric vehicle) 32 supported by the sub frame 28, the swing arm 16 swingably supported by the sub frame 28, and the electric motor 13 supported by the swing arm 16.

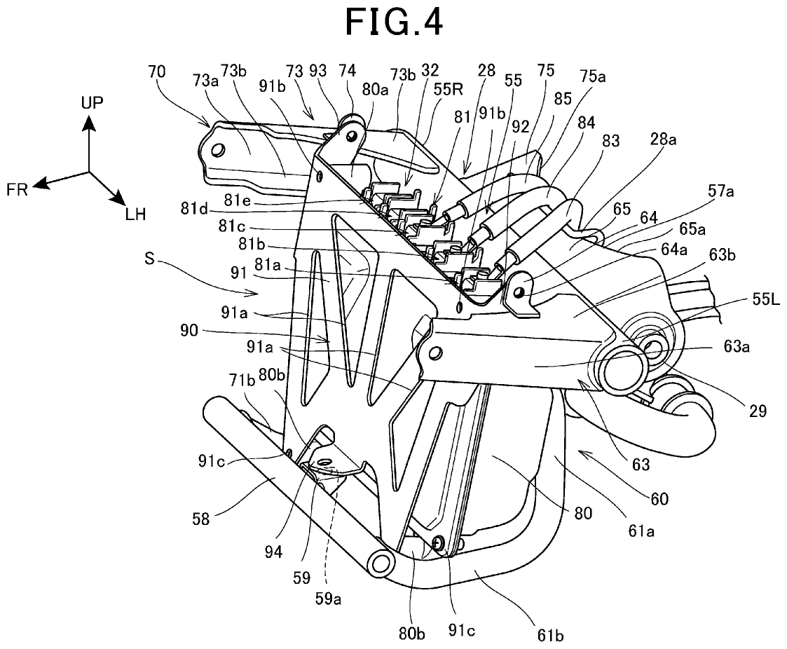

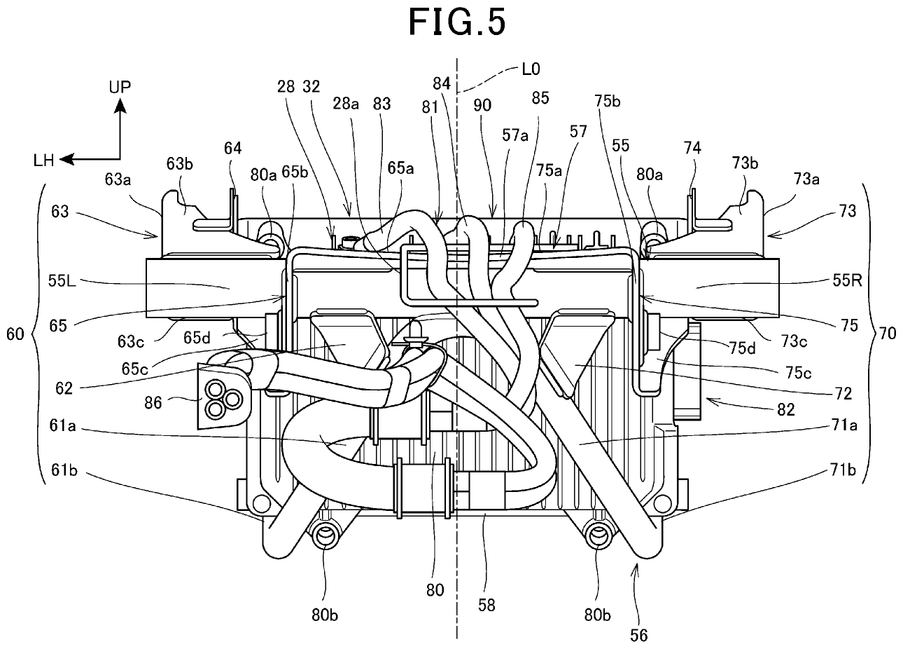

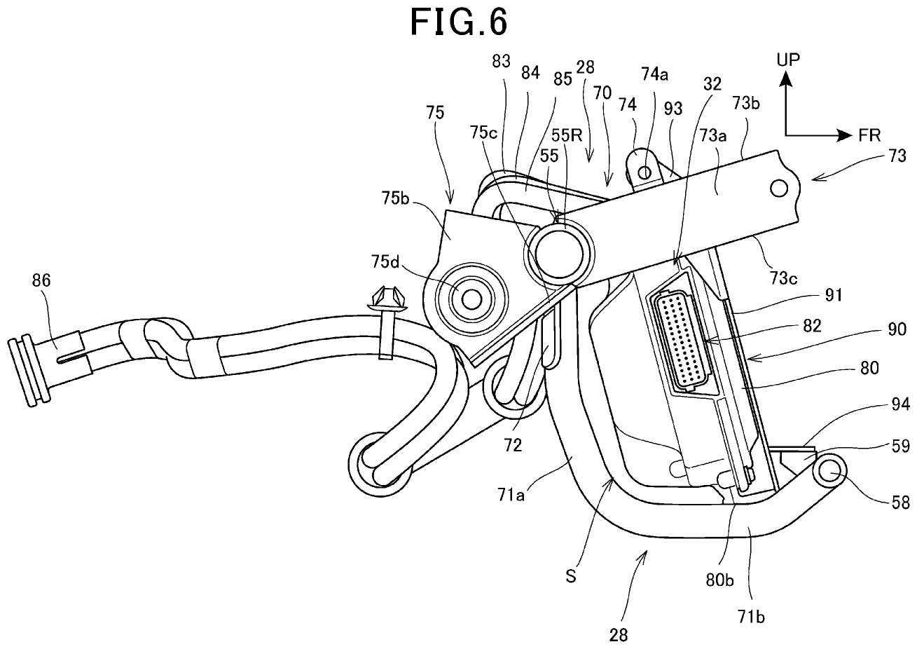

FIG. 4 is a perspective view as seen from the front left side illustrating the peripheral portion of the sub frame 28 and the PCU 32 related to the first embodiment of the present invention. FIG. 5 is a rear view illustrating the peripheral portion of the sub frame 28 and the PCU 32 related to the first embodiment of the present invention. FIG. 6 is a right side view illustrating the peripheral portion of the sub frame 28 and the PCU 32 related to the first embodiment of the present invention.

The sub frame 28 extends in the vehicle width direction. The sub frame 28 includes a left portion 60 arranged on the left side in the vehicle width direction and a right portion 70 arranged on the right side in the vehicle width direction.

As illustrated in FIG. 1, the left portion 60 includes a vertical pipe portion (base portion) 61a extending in the vertical direction, an upper connecting stay portion (upper connecting portion) 63 extending forward in a vehicle side view from the upper end of the vertical pipe portion 61a, and a lower connecting pipe portion (lower connecting portion) 61b extending forward in a vehicle side view from the lower end of the vertical pipe portion 61a.

As illustrated in FIG. 6, the right portion 70 includes a vertical pipe portion (base portion) 71a extending in the vertical direction, an upper connecting stay portion (upper connecting portion) 73 extending forward in a vehicle side view from the upper end of the vertical pipe portion 71a, and a lower connecting pipe portion 71b extending forward in a vehicle side view from the lower end of the vertical pipe portion 71a.

According to the present embodiment, the sub frame 28 is formed to be bilaterally symmetrical. That is to say, according to the present embodiment, the left portion 60 and the right portion 70 are bilaterally symmetrical. Also, in the sub frame 28, the left portion 60 and the right portion 70 are configured to be integral.

In concrete terms, the sub frame 28 includes an upper cross pipe (cross member, first cross member) 55 connecting the left and right sub frames 28 to each other, constituting a part of the base portion, and extending in the vehicle width direction (left and right direction). As illustrated in FIG. 5, the upper cross pipe 55 includes a pipe left portion 55L becoming the left side of the vehicle width center line L0 of the sub frame 28 and a pipe right portion 55R becoming the right side of the vehicle width center line L0.

As illustrated in FIG. 5, by the pipe left portion 55L, there is supported the vertical pipe portion 61a extending outward in the vehicle width direction and downward from the vehicle width center line L0. The vertical pipe portion 61a inclines to the left side in the vehicle width direction as it goes downward from the vehicle width center line L0. At the lower end of the vertical pipe portion 61a, the lower connecting pipe portion 61b extending forward is formed. The vertical pipe portion 61a is joined to the pipe left portion 55L by a reinforcement stay 62.

At the left end portion of the pipe left portion 55L, the upper connecting stay portion 63 extending forward is arranged. The upper connecting stay portion 63 is arranged on the left side of the lower connecting pipe portion 61b. The upper connecting stay portion 63 has a folded plate shape with a generally U-shape in cross section and extending forward. To be more specific, the upper connecting stay portion 63 includes a side surface portion 63a extending forward and having a plate shape. At the upper end of the side surface portion 63a, there is formed an upper surface portion 63b having a plate shape bent inward in the vehicle width direction. At the lower end of the side surface portion 63a, there is formed a lower surface portion 63c having a plate shape bent inward in the vehicle width direction. The lower surface portion 63c is folded so as to oppose the upper surface portion 63b.

The upper connecting stay portion 63 is joined in a state that the rear end of the side surface portion 63a is made to abut upon the front surface of the pipe left portion 55L and the upper surface portion 63b and the lower surface portion 63c respectively sandwich the pipe left portion 55L from the top and bottom. Thus, in the pipe left portion 55L, there is arranged the upper connecting stay portion 63 extending forward. In a vehicle side view, the upper connecting stay portion 63 has a shape extending forward from the upper end of the vertical pipe portion 61a.

In the upper surface portion 63b, there is formed an upper portion fixing stay 64 bent into a generally L-shape in a rear view. The upper portion fixing stay 64 is bent upward at the inner end in the vehicle width direction. In the upper portion fixing stay 64, there is formed a fixing hole 64a (refer to FIG. 4) extending in the vehicle width direction.

To the outer peripheral portion of the pipe left portion 55L, a gusset left portion 65 having a folded plate shape is joined. The gusset left portion 65 includes an upper surface portion 65a extending in the left and right direction along the upper surface of the pipe left portion 55L, a pivot portion 65b as the left surface portion bent downward from the left end of the upper surface portion 65a, and a left lower surface portion 65c bent outward in the vehicle width direction at the lower portion front end of the pivot portion 65b. The upper surface portion 65a, the pivot portion 65b, and the left lower surface portion 65c are joined to the upper cross pipe 55 at the front end.

As illustrated in FIG. 4 and FIG. 5, the rear edge of the upper surface portion 65a curves rearward as it goes outward in the vehicle width direction from the vehicle width center line L0.

As illustrated in FIG. 1, in a vehicle side view, the pivot portion 65b protrudes rearward from the upper cross pipe 55. In a vehicle side view, the pivot portion 65b has a generally fan shape whose vertical width increases as it goes rearward. By the rear end portion of the pivot portion 65b, there is supported a pivot insertion portion 65d having a cylindrical shape extending in the thickness direction.

The left portion 60 of the present embodiment is configured of the pipe left portion 55L, the vertical pipe portion 61a, the lower connecting pipe portion 61b, the reinforcement stay 62, the upper connecting stay portion 63, and the gusset left portion 65. Also, other members and shapes may be included in the left portion 60.

The right portion 70 that is bilaterally symmetrical is also formed similarly to the left portion 60.

To be more specific, as illustrated in FIG. 5, by the pipe right portion 55R, there is supported the vertical pipe portion 71a extending outward in the vehicle width direction and downward from the vehicle width center line L0. The vertical pipe portion 71a inclines to the right side in the vehicle width direction as it goes downward from the vehicle width center line L0. At the lower end of the vertical pipe portion 71a, the lower connecting pipe portion 71b extending forward is formed. The vertical pipe portion 71a is joined to the pipe right portion 55R by a reinforcement stay 72.

At the right end portion of the pipe right portion 55R, the upper connecting stay portion 73 extending forward is arranged. The upper connecting stay portion 73 is arranged on the right side of the lower connecting pipe portion 71b. The upper connecting stay portion 73 has a folded plate shape with a generally U-shape in cross section and extending forward. To be more specific, the upper connecting stay portion 73 includes a side surface portion 73a extending forward and having a plate shape. At the upper end of the side surface portion 73a, there is formed an upper surface portion 73b having a plate shape bent inward in the vehicle width direction. At the lower end of the side surface portion 73a, there is formed a lower surface portion 73c having a plate shape bent inward in the vehicle width direction. The lower surface portion 73c is folded so as to oppose the upper surface portion 73b.

The upper connecting stay portion 73 is joined in a state that the rear end of the side surface portion 73a is made to abut upon the front surface of the pipe right portion 55R and the upper surface portion 73b and the lower surface portion 73c respectively sandwich the pipe right portion 55R from the top and bottom. Thus, in the pipe right portion 55R, there is arranged the upper connecting stay portion 73 extending forward. In a vehicle side view, the upper connecting stay portion 73 has a shape extending forward from the upper end of the vertical pipe portion 71a.

In the upper surface portion 73b, there is formed an upper portion fixing stay 74 bent into a generally L-shape in a rear view. The upper portion fixing stay 74 is bent upward at the inner end in the vehicle width direction. In the upper portion fixing stay 74, there is formed a fixing hole 74a extending in the vehicle width direction (refer to FIG. 6).

To the outer peripheral portion of the pipe right portion 55R, a gusset right portion 75 having a folded plate shape is joined. The gusset right portion 75 includes an upper surface portion 75a extending in the left and right direction along the upper surface of the pipe right portion 55R, a pivot portion 75b as the right surface portion bent downward from the right end of the upper surface portion 75a, and a right lower surface portion 75c bent outward in the vehicle width direction at the lower portion front end of the pivot portion 75b. The upper surface portion 75a, the pivot portion 75b, and the right lower surface portion 75c are joined to the upper cross pipe 55 at the front end.

As illustrated in FIG. 4 and FIG. 5, the rear edge of the upper surface portion 75a curves rearward as it goes outward in the vehicle width direction from the vehicle width center line L0.

As illustrated in FIG. 6, in a vehicle side view, the pivot portion 75b protrudes rearward from the upper cross pipe 55. In a vehicle side view, the pivot portion 75b has a generally fan shape whose vertical width increases as it goes rearward. By the rear end portion of the pivot portion 75b, there is supported a pivot insertion portion 75d having a cylindrical shape extending in the thickness direction.

The right portion 70 of the present embodiment is configured of the pipe right portion 55R, the vertical pipe portion 71a, the lower connecting pipe portion 71b, the reinforcement stay 72, the upper connecting stay portion 73, and the gusset right portion 75. Also, other members and shapes may be included in the right portion 70.

Here, the vertical pipe portion 61a of the left portion 60 and the vertical pipe portion 71a of the right portion 70 curve so as to be along the upper cross pipe 55 at the front end side, and are connected to each other.

That is to say, according to the present embodiment, the vertical pipe portion 61a of the left portion 60 and the vertical pipe portion 71a of the right portion 70 have an integral pipe shape. The vertical pipe portion 61a and the lower connecting pipe portion 61b of the left portion 60 as well as the vertical pipe portion 71a and the lower connecting pipe portion 71b of the right portion 70 are configured of a partial shape of an integral pipe material 56 formed by bending work.

Also, the gusset left portion 65 of the left portion 60 and the gusset right portion 75 of the right portion 70 are connected to each other in the vehicle width direction.

That is to say, according to the present embodiment, the gusset left portion 65 of the left portion 60 and the gusset right portion 75 of the right portion 70 have an integral bent plate shape. The gusset left portion 65 of the left portion 60 and the gusset right portion 75 of the right portion 70 are configured of an integral pivot gusset 57 formed by bending work. In the pivot gusset 57, a curved portion 57a recessed forward (refer to FIG. 4) is formed by the rear end of the upper surface portion 65a of the gusset left portion 65 and the rear end of the upper surface portion 75a of the gusset right portion 75.

Between the front end portion of the lower connecting pipe portion 61b of the left portion 60 and the front end portion of the lower connecting pipe portion 71b of the right portion 70, there is fixed a lower cross pipe (cross member, second cross member) 58 extending in the vehicle width direction. Thus, the lower connecting pipe portions 61b, 71b having an elongate shape are reinforced. At the center portion in the vehicle width direction of the lower cross pipe 58, a lower portion fixing stay 59 is arranged (refer to FIG. 4). In the lower portion fixing stay 59, there is formed a through hole 59a (refer to FIG. 4) penetrating in the vertical direction.

As illustrated in FIG. 4 to FIG. 6, in the sub frame 28, by the vertical pipe portions 61a, 71a, the upper connecting stay portions 63, 73, and the lower connecting pipe portions 61b, 71b, there is formed a space having a generally U-shape in a vehicle side view whose front is opened. Also, in the sub frame 28, by the upper connecting stay portions 63, 73 and the lower connecting pipe portions 61b, 71b of the left and right, there is formed a space sandwiched in the left and right direction in a vehicle front view. That is to say, in the sub frame 28, by the vertical pipe portions 61a, 71a, the upper connecting stay portions 63, 73, and the lower connecting pipe portions 61b, 71b, there is configured an electric component disposal space S (refer to FIG. 4) whose front is opened.

According to the present embodiment, in the electric component disposal space S, the PCU 32 as an example of the functional component of the electric vehicle is disposed. The PCU 32 includes a PCU body portion that is an electronic device not illustrated, a casing 80 having a rectangular parallelepiped shape storing the PCU body portion, a power terminal portion (terminal) 81 arranged on the upper surface of the casing 80, and a communication terminal unit 82 arranged on the right side surface of the casing 80. In the casing 80, at positions corresponding to four corners of the rectangular shape in a rear view illustrated in FIG. 5, fastening portions 80a, 80b (refer to FIG. 5) having a cylindrical shape are formed. The fastening portions 80a, 80b extend in the front and rear direction. By fastening a fastening member to the fastening portions 80a, 80b, the PCU 32 is fixed to the sub frame 28.

To be more specific, the casing 80 of the PCU 32 is fixed to the sub frame 28 through a bracket 90.

As illustrated in FIG. 4, the bracket 90 includes a base surface 91 having a plate shape. In a front view, the base surface 91 is formed into a generally trapezoidal shape. In the base surface 91, there are formed appropriate lightening holes 91a penetrating in the thickness direction. By the lightening holes 91a, the casing 80 of the PCU 32 is exposed to the front of the bracket 90. By the lightening holes 91a, the external air contacts the PCU 32, and the PCU 32 comes to easily radiate heat. At four corners of the base surface 91, there are formed fastening holes 91b, 91c penetrating in the front and rear direction. To the fastening holes 91b, 91c of the four corners, fastening members are inserted respectively from the front. These fastening members are fastened respectively to four fastening portions 80a, 80b of the casing 80 of the PCU 32. The fastening portions 80b of the lower side are positioned lower than the lower cross pipe 58, and are fastened from the front at a position lower than the lower cross pipe 58. Thus, the PCU 32 is fixed to the bracket 90.

At the upper end portion of the bracket 90 and on the left side of the base surface 91, there is formed a left fixing portion 92 having a shape folded to the rear. The left fixing portion 92 is fixed to the upper portion fixing stay 64 of the left portion 60 of the sub frame 28. To the upper portion fixing stay 64, a fastening member is inserted from the left side.

At the upper end portion of the bracket 90 and on the right side of the base surface 91, there is formed a right fixing portion 93 having a shape folded to the rear. The right fixing portion 93 is fixed to the upper portion fixing stay 74 of the right portion 70 of the sub frame 28. To the upper portion fixing stay 74, a fastening member is inserted from the right side.

At the lower end portion of the bracket 90 and at the center portion in the vehicle width direction of the base surface 91, there is formed a flection fixing portion 94 folded forward in a so-called cutting and raising manner. The flection fixing portion 94 is fixed to the lower portion fixing stay 59 of the sub frame 28. To the lower portion fixing stay 59, a fastening member is inserted from above.

The bracket 90 is fastened in the left and right direction in the upper portion. Also, the bracket 90 is fastened in the vertical direction in the lower portion. Since the bracket 90 is fastened in plural directions of the left and right direction and the vertical direction, it becomes easy for the bracket 90 to be fixed tightly to the sub frame 28. The bracket 90 is fixed to the sub frame 28 by three points in total. Thus, the PCU 32 is fixed to the sub frame 28 though the bracket 90.

The PCU 32 is fixed to the sub frame 28 at a position sandwiched by the bracket 90 and the base portion (the vertical pipe portions 61a, 71a) of the sub frame 28 in the front and rear direction and sandwiched by the left and right upper connecting stay portions 63, 73 and the lower connecting pipe portions 61b, 71b of the sub frame 28 in the left and right direction. Since the PCU 32 is fixed to the sub frame 28 through the bracket 90, the PCU 32 of other shapes can be mounted only by changing the specification and shape of the bracket 90. Also, since it is facilitated to absorb an external force applied to the sub frame 28 by the bracket 90, it is suppressed that the external force is transferred to the PCU 32.

As illustrated in FIG. 4, the power terminal portion 81 of the PCU 32 includes 3-phase AC terminals 81a, 81b, 81c corresponding to U phase, V phase, and W phase and DC power terminals 81d, 81e. To the 3-phase AC terminals 81a, 81b, 81c, 3-phase AC high voltage wiring (wiring) 83, 84, 85 are connected. The high voltage wiring 83 to 85 pass the upper side of the upper cross pipe 55 while being guided by the upper cross pipe 55, and are cabled to the pivot gusset 57 located behind. In the pivot gusset 57, the high voltage wiring 83 to 85 are cabled to the rear surface of the sub frame 28 while curving downward at the curved portion 57a. On the rear surface of the sub frame 28, there is arranged an engage bar 28a having a folded bar shape, and the high voltage wiring 83 to 85 are hooked by the engage bar 28a and held. At the distal end (rear end) of the high voltage wiring 83 to 85, a connector 86 is arranged (refer to FIG. 5). The connector 86 is connected to the electric motor 13 that is supported by the swing arm 16.

As illustrated in FIG. 2 and FIG. 3, the swing arm 16 is swingably supported by the sub frame 28.

The swing arm 16 includes a swing arm body 110 supporting the rear wheel 12, and a swing arm cover 111 attached to the outside in the vehicle width direction of the swing arm body 110. The swing arm body 110 extends to the left and right in front of the rear wheel 12, and extends in the front and rear direction on the left side of the rear wheel 12 at the rear thereof. The swing arm body 110 has such shape that the outside in the vehicle width direction is opened. In the swing arm body 110, there are stored the electric motor 13 and a power transmission mechanism (not illustrated) transmitting the power of the electric motor 13 to the rear wheel 12. The swing arm body 110 is closed by the swing arm cover 111 from the outside in the vehicle width direction.

As illustrated in FIG. 3, in front of the rear wheel 12, the swing arm body 110 extends in the left and right direction so as to cross the vehicle width center line L1 of the vehicle width direction of the electric vehicle 10. At the front end portion of the swing arm body 110, a pair of left and right pivot connecting portions 110a, 110b are formed. The pivot connecting portions 110a, 110b are disposed between the pivot insertion portions 65d, 75d of the sub frame 28. Also, in the pivot connecting portions 110a, 110b of the swing arm 16 and the pivot insertion portions 65d, 75d of the sub frame 28, the pivot shaft 29 in one piece is inserted. Thus, the swing arm 16 is swingably supported by the sub frame 28 through the pivot shaft 29.

In the rear portion of the swing arm body 110, the electric motor 13 is stored. The electric motor 13 is disposed in the lateral side of the rear wheel 12. That is to say, according to the present embodiment, the electric motor 13 is so-called a wheel-side motor. To the electric motor 13, there are connected the high voltage wiring 83 to 85 extending from the PCU 32. The high voltage wiring 83 to 85 are introduced to the inside of the swing arm body 110 from an opening 110c formed at the front end portion of the swing arm body 110, and the connector 86 of the high voltage wiring 83 to 85 is connected to the electric motor 13. PCU 32 supplies AC power to the electric motor 13, and controls the electric motor 13.

The swing arm unit 100 of the present embodiment is configured of the sub frame 28, the swing arm 16, the electric motor 13, the PCU 32, and the like.

The swing arm unit 100 is attached to the body frame 11. According to the present embodiment, the swing arm unit 100 is attached to the rising frame portions 25 of the left and right side frames 24.

In concrete terms, with respect to the sub frame 28, the upper connecting stay portions 63, 73 are disposed on the outside in the vehicle width direction of the rising frame portions 25, and the lower cross pipe 58 of the lower connecting pipe portions 61b, 71b is disposed on the inside in the vehicle width direction of the rising frame portions 25.

Also, the upper connecting stay portion 63 of the left portion 60 is fixed to the outer surface in the vehicle width direction of the rising frame portion 25 of the left side by a connecting member extending in the left and right direction in a state of being made to abut upon the outer surface in the vehicle width direction of the rising frame portion 25 of the left side.

Also, the upper connecting stay portion 73 of the right portion 70 is fixed to the outer surface in the vehicle width direction of the rising frame portion 25 of the right side by a connecting member extending in the left and right direction in a state of being made to abut upon the outer surface in the vehicle width direction of the rising frame portion 25 of the right side.

Further, in the lower cross pipe 58 of the lower connecting pipe portions 61b, 71b, a connecting member extending in the left and right direction is inserted, and is connected to the inside of the left and right rising frame portions 25.

Therefore, the sub frame 28 turnably supporting the swing arm 16 is attached to the body frame 11 by three pieces of the connecting members extending in the left and right direction.

Here, with respect to the swing arm unit 100, it is possible to connect, in advance, wiring such as the high voltage wiring 83 to 85 between the electric motor 13 and the PCU 32 before being attached to the body frame 11. Accordingly, compared to a case where wiring of the electric motor and the PCU is connected after attaching the swing arm including the electric motor to the vehicle body, connecting work of the wiring is possible in a state where there is not the body frame 11 and the like, and therefore wiring can be connected easily.

When the sub frame 28 of the swing arm unit 100 is attached to the body frame 11, the rear cushion 30 extending from above is connected to the rear end portion of the swing arm unit 100. Also, a connector of a communication line extending from an ECU (Electronic Control Unit) not illustrated of the body frame 11 is connected to the communication terminal unit 82 (refer to FIG. 6) of the PCU 32 from the light side of the sub frame 28. As illustrated in FIG. 6, in the right portion 70, the communication terminal unit 82 is exposed to the right direction from a gap of the bracket 90, the vertical pipe portion 71a, the upper connecting stay portion 73, and the lower connecting pipe portion 71b, and the connection work of the connector of the communication line is facilitated.

According to the present embodiment, assembly work of the electric vehicle 10 is facilitated.

As explained above, according to the first embodiment to which the present invention is applied, the electric vehicle 10 includes the swing arm 16 swingably supported by a vehicle body through the pivot shaft 29, the electric motor 13 arranged in the swing arm 16 and driving the rear wheel 12, and the functional component 32 of the electric vehicle electrically connected to the electric motor 13. In the electric vehicle 10, the sub frame 28 is provided, the sub frame 28 being separate from the body frame 11 configuring the vehicle body and being attachable to the body frame 11, the sub frame 28 includes the pivot portions 65b, 75b swingably supporting the swing arm 16, and the functional component 32 of the electric vehicle is supported by the sub frame 28.

According to this configuration, by allowing the sub frame 28 to support the swing arm 16 supporting the electric motor 13 and the functional component 32 of the electric vehicle electrically connected to the electric motor 13, it can be configured that the swing arm 16, the functional component 32 of the electric vehicle, and so on are made a unit and are preassembled. Therefore, the swing arm 16 provided with the electric motor 13 can be attached to the vehicle body after connecting wiring between the electric motor 13 and the functional component 32 of the electric vehicle, and performance in assembling the electric motor 13 and the functional component 32 of the electric vehicle can be improved. Also, since the functional component 32 of the electric vehicle is not arranged in the swing arm 16, the swinging weight of the swing arm 16 can be lightened.

Therefore, in the electric vehicle 10 including the swing arm 16 supporting the electric motor 13, it is possible to provide the electric vehicle 10 having excellent performance in assembling the swing arm 16 including the electric motor 13 and the functional component 32 of the electric vehicle while suppressing the swing arm 16 from becoming large in size and the mass of an unsprung portion that is a portion swinging along with the swing arm 16 from increasing.

According to the present embodiment, the sub frame 28 includes the vertical pipe portions 61a, 71a extending in the vertical direction, and the sub frame 28 includes at least two connection portions of the top and bottom of the upper connecting stay portions 63, 73 and the lower connecting pipe portions 61b, 71b connecting the vertical pipe portions 61a, 71a to the body frame 11.

According to this configuration, since the sub frame 28 includes the vertical pipe portions 61a, 71a extending in the vertical direction, it is facilitated to support the functional component 32 of the electric vehicle in a space of the vertical direction formed by the vertical pipe portions 61a, 71a. Also, since the sub frame 28 is supported by two positions of the top and bottom, the swing arm 16 can be supported with rigidity.

Also, according to the present embodiment, the upper connecting stay portions 63, 73 extend forward of the vehicle body from the upper portion of the vertical pipe portions 61a, 71a in a vehicle side view and are connected to the body frame 11, and the lower connecting pipe portions 61b, 71b extend forward of the vehicle body from the lower portion of the vertical pipe portions 61a, 71a in a vehicle side view and are connected to the body frame 11 through the lower cross pipe 58.

According to this configuration, since the upper connecting stay portions 63, 73 and the lower connecting pipe portions 61b, 71b are allowed to extend to the front and to be connected to the body frame 11, a space of the front and rear direction can be arranged between the vertical pipe portions 61a, 71a and the body frame 11, and it is facilitated to store the functional component 32 of the electric vehicle in the space.

Also, according to the present embodiment, the sub frame 28 includes the left portion 60 and the right portion 70, the left portion 60 and the right portion 70 include the vertical pipe portions 61a, 71a, the upper connecting stay portions 63, 73, and the lower connecting pipe portions 61b, 71b corresponding to the left portion 60 and the right portion 70 respectively, and the sub frame 28 includes the upper cross pipe 55 and the lower cross pipe 58 connecting the left portion 60 and the right portion 70 to each other.

According to this configuration, a space in the left and right direction can be formed by allowing the sub frame 28 to have a pair of left and right shapes, and it is facilitated to store the functional component 32 of the electric vehicle in the space. Also, the strength of the sub frame 28 can be further increased by the upper cross pipe 55 and the lower cross pipe 58.

Also, according to the present embodiment, the functional component 32 of the electric vehicle is disposed between the left portion 60 and the right portion 70, is positioned between the body frame 11 and the vertical pipe portions 61a, 71a in a vehicle front and rear direction, and is positioned between the upper connecting stay portions 63, 73 and the lower connecting pipe portions 61b, 71b in a vertical direction.

According to this configuration, since the functional component 32 of the electric vehicle is disposed within a space formed by the sub frame 28, the functional component 32 of the electric vehicle can be supported by the sub frame 28 with strength while allowing the layout of the functional component 32 of the electric vehicle to be compact.

Also, according to the present embodiment, the functional component 32 of the electric vehicle is connected to the sub frame 28 through the bracket 90.

According to this configuration, since the functional component 32 of the electric vehicle is attached to the sub frame 28 through the bracket 90, the degree of freedom in attaching the functional component 32 of the electric vehicle can be increased.

Also, according to the present embodiment, the upper cross pipe 55 is provided, the upper end portion of the vertical pipe portions 61a, 71a being connected to the upper cross pipe 55, the power terminal portion 81 of the functional component 32 of the electric vehicle is positioned in the upper portion, the wiring 83 to 85 connected to the power terminal portion 81 of the functional component 32 of the electric vehicle are provided, and the wiring 83 to 85 pass the upper side of the upper cross pipe 55 and are cabled to the electric motor 13.

According to this configuration, the upper cross pipe 55 can be utilized as a guide for the wiring 83 to 85 facilitating routing of the wiring 83 to 85.

Also, according to the present embodiment, the functional component 32 of the electric vehicle is the PCU 32 supplying high voltage power to the electric motor 13.

According to this configuration, it is possible to attach the swing arm 16 provided with the electric motor 13 to the vehicle body after connecting the high voltage wiring 83 to 85 between the electric motor 13 and the PCU 32. Therefore, it is possible to connect the high voltage wiring 83 to 85 liable to become thick and rigid extending from the PCU 32 without being affected by the body frame 11, and performance in assembling the electric motor 13 and the PCU 32 can be improved.

Also, according to the present embodiment, there is provided the upper cross pipe 55 to which the upper end portion of the vertical pipe portions 61a, 71a is connected, and the pivot gusset 57 including the pivot portions 65b, 75b is arranged between the upper cross pipe 55 and the vertical pipe portions 61a, 71a.

According to this configuration, the swing arm 16 can be supported by the sub frame 28 while further improving the strength of the sub frame 28.

### Second Embodiment

The second embodiment to which the present invention is applied will be explained. In the second embodiment, a portion configured similarly to the first embodiment described above will be marked with a same reference sign, and explanation thereof will be omitted.

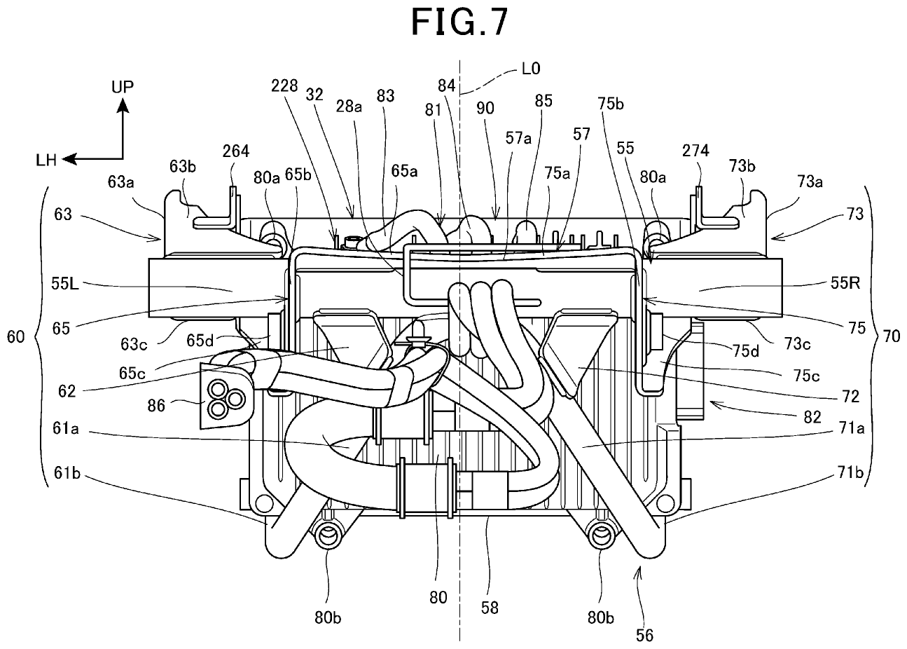

FIG. 7 is a rear view illustrating the peripheral portion of a sub frame 228 and the PCU 32 related to the second embodiment of the present invention.

The sub frame 228 related to the second embodiment is different from the first embodiment in the point of including upper portion fixing stays 264, 274 instead of the upper portion fixing stays 64, 74 of the sub frame 28 of the first embodiment. The upper portion fixing stays 264, 274 of the second embodiment are formed on the front side of the upper portion fixing stays 64, 74 of the first embodiment. Thus, in the sub frame 228 of the second embodiment, the PCU 32 is apart to the front from the upper cross pipe 55, and a wide space is easily formed between the upper cross pipe 55 and the PCU 32.

According to the second embodiment, through this space between the upper cross pipe 55 and the PCU 32, the high voltage wiring 83 to 85 extending from the PCU 32 are made to pass from above. The high voltage wiring 83 to 85 having been made to pass through from above pass below the upper cross pipe 55 while being guided by the upper cross pipe 55, and are cabled to the rear of the upper cross pipe 55. The high voltage wiring 83 to 85 having been cabled to the rear of the upper cross pipe 55 are held by the engage bar 28a and are cabled to the rear side. Thus, according to the second embodiment, the high voltage wiring 83 to 85 are cabled to the rear side, and the connector 86 of the high voltage wiring 83 to 85 is connected to the electric motor 13.

The second embodiment is similar to the first embodiment excepting a point that the high voltage wiring 83 to 85 are configured to pass below the upper cross pipe 55. Therefore, also in the second embodiment to which the present invention is applied, in the electric vehicle 10 where the electric motor 13 is supported by the swing arm 16, it is possible to provide the electric vehicle 10 easy in connecting wiring to the electric motor 13 and having excellent performance in assembling the electric motor 13 and the swing arm 16 while suppressing the mass of an unsprung portion from increasing.

Particularly, according to the present embodiment, there is provided the upper cross pipe 55 to which the upper end portion of the vertical pipe portion 61a, 71a are connected, the power terminal portion 81 of the PCU 32 is positioned in the upper portion, there are provided the high voltage wiring 83 to 85 connected to the power terminal portion 81 of the PCU 32, and the high voltage wiring 83 to 85 are cabled to the electric motor 13 passing the lower side of the upper cross pipe 55.

According to this configuration, the upper cross pipe 55 can be utilized as a guide for the wiring 83 to 85 facilitating routing of the wiring 83 to 85.

### Third Embodiment

The third embodiment to which the present invention is applied will be explained. In the third embodiment, a portion configured similarly to the first or the second embodiment described above will be marked with a same reference sign, and explanation thereof will be omitted.

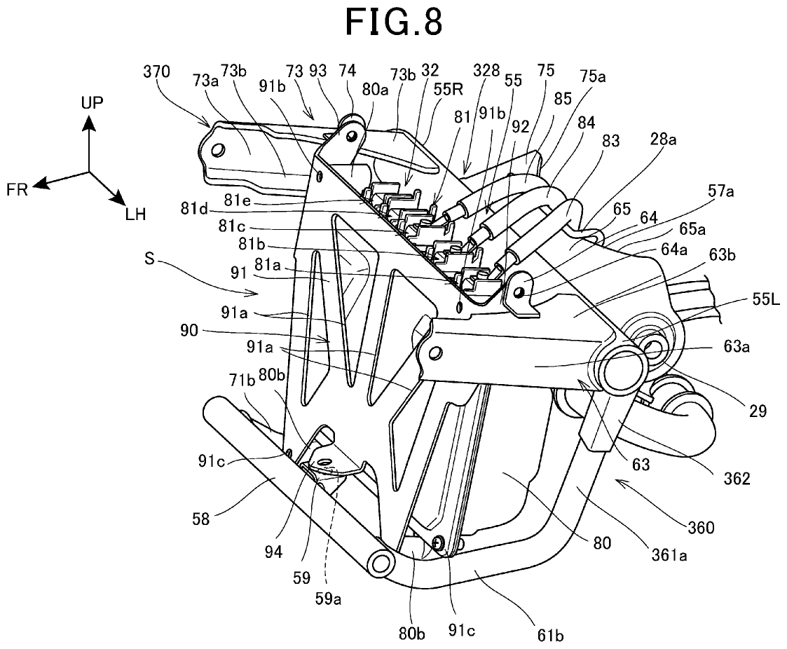

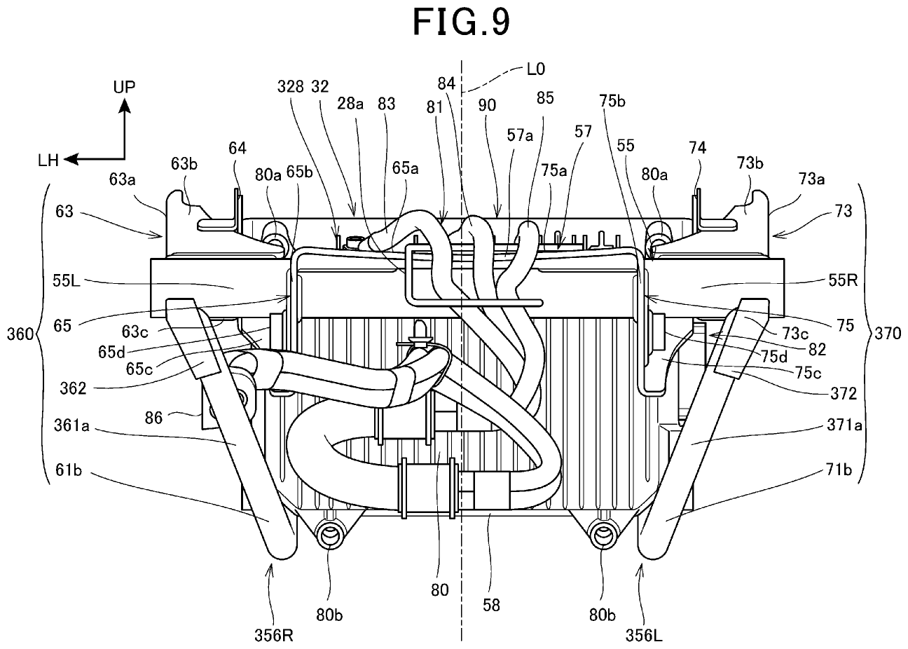

FIG. 8 is a perspective view as seen from the front left side illustrating a peripheral portion of a sub frame 328 and the PCU 32 related to the third embodiment of the present invention. FIG. 9 is a rear view illustrating the peripheral portion of the sub frame 328 and the PCU 32 related to the third embodiment of the present invention.

The sub frame 328 related to the third embodiment is different from the first embodiment in the point of including vertical pipe portions 361a, 371a and gussets 362, 372 instead of the vertical pipe portions 61a, 71a and the reinforcement stays 62, 72 of the sub frame 28 of the first embodiment.

That is to say, as illustrated in FIG. 9, to each of the pipe left portion 55L and the pipe right portion 55R, there are connected the vertical pipe portions 361a, 371a extending upward from the rear end of the lower connecting pipe portions 61b, 71b. Each of the vertical pipe portions 361a, 371a of the left and right extends linearly outward in the vehicle width direction as it goes upward. Each of the upper ends of the vertical pipe portions 361a, 371a is connected to the pipe left portion 55L and the pipe right portion 55R respectively. The upper ends of the vertical pipe portions 361a, 371a are reinforced by the gussets 362, 372, and are fixed to the pipe left portion 55L and the pipe right portion 55R respectively.

According to the present embodiment, the vertical pipe portion 361a and the lower connecting pipe portion 61b of a left portion 360 are in a partial shape of an integral pipe material 356R. Also, according to the present embodiment, the vertical pipe portion 371a and the lower connecting pipe portion 71b of a right portion 370 are in a partial shape of an integral pipe material 356L. The pipe material 356R and the pipe material 356L are separate from each other.

That is to say, according to the first embodiment, the vertical pipe portion 61a and the lower connecting pipe portion 61b of the left portion 60 as well as the vertical pipe portion 71a and the lower connecting pipe portion 71b of the right portion 70 were in a partial shape of the integral pipe material 56. On the other hand, according to the third embodiment, the vertical pipe portion 361a and the lower connecting pipe portion 61b of the left portion 360 as well as the vertical pipe portion 371a and the lower connecting pipe portion 71b of the right portion 370 are configured to be in a separate shape having been divided.

The third embodiment is similar to the first embodiment excepting a point that the vertical pipe portion 361a and the lower connecting pipe portion 61b of the left portion 360 as well as the vertical pipe portion 371a and the lower connecting pipe portion 71b of the right portion 370 are separate from each other. Therefore, also in the third embodiment to which the present invention is applied, in the electric vehicle 10 where the electric motor 13 is supported by the swing arm 16, it is possible to provide the electric vehicle 10 easy in connecting wiring to the electric motor 13 and having excellent performance in assembling the electric motor 13 and the swing arm 16 while suppressing the mass of an unsprung portion from increasing.

### Fourth Embodiment

The fourth embodiment to which the present invention is applied will be explained. In the fourth embodiment, a portion configured similarly to the first to the third embodiment described above will be marked with a same reference sign, and explanation thereof will be omitted.

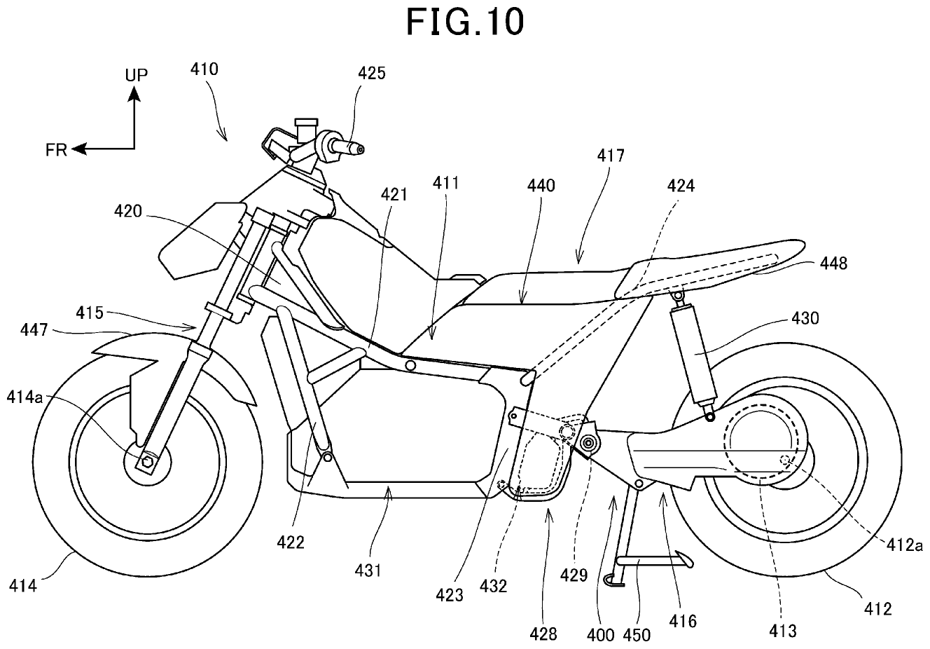

FIG. 10 is a left side view of an electric vehicle 410 related to the fourth embodiment of the present invention.

An electric vehicle 410 in the fourth embodiment is of a vehicle kind different from that of the electric vehicle 10 in the first to the third embodiments. Responding to it, the electric vehicle 410 is different from the electric vehicle 10 in the first embodiment with respect to a body frame 411 and a body cover 440. Here, in relation with the configuration of the electric vehicle 410, on the configuration corresponding to the electric vehicle 10 in the first embodiment, with respect to those other than the body frame 411 and the body cover 440, by attaching “4” for the third digit of the reference sign of the first embodiment, explanation thereof will be omitted.

The body frame 411 of the electric vehicle 410 includes a head pipe 420 of the front end portion, a pair of left and right main frames 421 extending obliquely downward to the rear from the upper portion of the head pipe 420, a pair of left and right down frames 422 extending downward to the rear from the front end portion of the main frames 421 at an angle steeper than that of the main frames 421, a pair of left and right center frames 423 extending downward from the rear end portion of the main frames 421, and a pair of left and right seat frames 424 extending upward to the rear from the center frames 423. In a space surrounded by the main frames 421, the down frames 422, and the center frames 423 in a vehicle side view, a battery 431 is disposed. The battery 431 is supported by the body frame 411.

To the center frames 423, a sub frame 428 of a swing arm unit 400 is attached from the rear. Therefore, in the present embodiment also, a swing arm 416 of the swing arm unit 400 is swingably supported by the body frame 411. The swing arm 416 is connected to a rear cushion 430 extending downward from the seat frame 424 of the left side. The sub frame 428 is covered with the body cover 440.

In the electric vehicle 410 also of the fourth embodiment, a point that the swing arm unit 400 is attached to the body frame 411 is similar to the first embodiment. Therefore, also in the fourth embodiment to which the present invention is applied, in the electric vehicle 410 where the electric motor 413 is supported by the swing arm 416, it is possible to provide the electric vehicle 410 easy in connecting wiring to the electric motor 413 and having excellent performance in assembling the electric motor 413 and the swing arm 416 while suppressing the mass of an unsprung portion from increasing.

### OTHER EMBODIMENTS

The embodiments described above only show an aspect of the present invention, and modification and application are optionally possible in a range not deviating from the gist of the present invention.

In the sub frames 28, 228, 328, 428 of the embodiments described above, although such configuration was explained that the upper connecting stay portions 63, 73 and the vertical pipe portions 61a, 71a are connected to each other through the upper cross pipe 55, the present invention is not limited to it. For example, the upper end of the vertical pipe portions 61a, 71a may extend further to be folded forward, and the upper end portion of the vertical pipe portions 61a, 71a may configure an upper connecting portion extending forward in a vehicle side view.

In the sub frames 28 to 428 of the embodiments described above, although such configuration was explained that the upper connecting stay portions 63, 73 and the lower connecting pipe portions 61b, 71b extending forward were arranged in the top and bottom of the vertical pipe portions 61a, 71a respectively, the configuration of the sub frames 28 to 428 is not limited to it. For example, it may be configured that either one of the upper connecting stay portions 63, 73 and the lower connecting pipe portions 61b, 71b arranged in the top and bottom of the vertical pipe portions 61a, 71a is omitted. In other words, at least one of the upper connecting portion and the lower connecting portion may be configured to extend forward of the vehicle body from the base portion 61a, 71a, 361a, 371a in a vehicle side view to be connected to the body frame 11, 411. In this case, a space having a generally triangular shape in a vehicle side view can be formed by the sub frame. Also, it is easy to attach the sub frame to the body frame with an attitude of extending the base portion in the vertical direction, the body frame inclining obliquely.

In the sub frames 28 to 428 of the embodiments described above, although the configuration of including the upper cross pipe 55 and the lower cross pipe 58 was explained, the present invention is not limited to it. It may be configured that the left portion 60, 360 and the right portion 70, 370 are connected integrally by either one of the upper cross pipe 55 or the lower cross pipe 58. Also, the sub frames 28 to 428 may include a cross member extending in the vehicle width direction in addition to the upper cross pipe 55 and the lower cross pipe 58, and may include cross members of three pieces or more. Further, the cross member may be arranged in a middle portion in the longitudinal direction of the base portion without being limited to the upper end and the lower end of the base portion.

In the sub frames 28 to 428 of the embodiments described above, although such configuration was exemplified that the left portion 60 and the right portion 70 were bilaterally symmetrical to each other, the left portion 60 and the right portion 70 may be configured to be bilaterally non-symmetrical to each other.

In the sub frames 28 to 428 of the embodiments described above, although such configuration was exemplified that the left portion 60, 360 and the right portion 70, 370 were separated to the left and right excepting the upper cross pipe 55 and the lower cross pipe 58, the present invention is not limited to it, and the left portion 60, 360 and the right portion 70, 370 may not be of a separate construction with respect to those other than the upper cross pipe 55 and the lower cross pipe 58. For example, a base portion having an integral shape in the left portion and the right portion may be configured by one sheet of plate material instead of the vertical pipe portions 61a, 71a of the left and right. Also, an upper connecting portion having an integral shape in the left portion and the right portion may be configured by one sheet of plate material instead of the upper connecting stay portions 63, 73. Further, a lower connecting portion having an integral shape in the left portion and the right portion may be configured by one sheet of plate material instead of the lower connecting pipe portions 61b, 71b. Therefore, the base portion, the upper connection portion, and the lower connecting portion may be configured into an integral shape by a shape obtained by folding one sheet of plate material in a vehicle side view for example.

That is to say, as described above, the sub frame may be either of a shape of a pair of the left and right or an integral shape of the left and right as far as it is constructed to include a component extending in the vertical direction (base portion) and attaching portions of the top and bottom extending forward.

In the sub frames 28 to 428 of the embodiments described above, as a configuration that the pivot insertion portions 65d, 75d were arranged between the upper cross pipe 55 and the base portions 61a, 71a, 361a, 371a, although such configuration was explained that the pivot insertion portions 65d, 75d were arranged in the pivot gusset 57 arranged between the upper cross pipe 55 and the base portions 61a, 71a, 361a, 371a, the pivot insertion portions 65d, 75d may not be arranged in the reinforcement member. That is to say, the pivot insertion portions 65d, 75d may be arranged at positions between the upper cross pipe 55 and the base portions 61a, 71a, 361a, 371a separately from the reinforcement member.

According to the fourth embodiment described above, although such configuration was explained that the body frame 411 included the head pipe 420, the main frames 421, the down frames 422, the center frames 423, and the seat frames 424, the configuration of the body frame 411 is not limited to it. For example, the body frame 411 may also include a battery case and the like equivalent to a frame supported across the down frame 422 and the main frame 421 and storing the battery 431. That is to say, although such configuration was explained that the sub frame 428 of the swing arm unit 400 was attached to the center frame 423, the sub frame 428 of the swing arm unit 400 may be attached to a battery case and the like.

In the embodiments described above, as a configuration that the electric motor 13, 413 was supported by the swing arm 16, 416, although there was exemplified a configuration of the wheel-side motor where the power was transferred from the electric motor 13, 413 to the rear wheel 12, 412 through a speed reduction mechanism as a power transfer member, the electric motor 13, 413 being disposed on the lateral side of the rear wheel 12, 412, the configuration where the electric motor 13, 413 is supported by the swing arm 16, 416 is not limited to this configuration of the wheel-side motor. For example, such configuration is also possible that the electric motor 13 is disposed at a position immediately lateral to a wheel of the rear wheel 12, 412, and that the driving shaft of the electric motor 13, 413 and the rear wheel shaft is mad identical to eliminate the speed reduction mechanism. Also, the electric motor 13, 413 may be supported by the swing arm 16, 416 using a configuration where the electric motor 13, 413 is stored in the wheel of the rear wheel 12, 412 namely a configuration of a so-called in-wheel motor.

In the embodiments described above, although the PCU 32 was exemplified as a functional component of the electric vehicle supported by the sub frame 28 to 428, a functional component such as a battery and an on-board charger for charging a battery may be supported instead of the PCU 32, the functional component not being required for a vehicle driven by an internal combustion engine but being peculiar to the electric vehicle 10, 410. Further, although the PCU 32 was exemplified as a functional component of the electric vehicle, a control member such as a PDU and ECU for example controlling the electric motor 13 may be supported instead of the PCU 32.

Although explanation was made exemplifying a saddle riding type motorcycle including the front wheel 14 and the rear wheel 12 as the electric vehicle 10 in the embodiments described above, the present invention is not limited to it, and is applicable to a three-wheeled saddle riding type electric vehicle including two front wheels or two rear wheels, or a saddle riding type electric vehicle including four wheels or more.

### [Configurations Supported by the Embodiments Described Above]

The embodiments described above support following configurations.

### (First Configuration)

An electric vehicle includes a swing arm swingably supported by a vehicle body through a pivot shaft, a motor arranged in the swing arm and driving a driving wheel, and a functional component of the electric vehicle electrically connected to the motor. In the electric vehicle, a sub frame is provided, the sub frame being separate from a body frame configuring the vehicle body and being attachable to the body frame, the sub frame includes a pivot portion swingably supporting the swing arm, and the functional component of the electric vehicle is supported by the sub frame.

According to this configuration, by allowing the sub frame to support the swing arm supporting the motor and the functional component of the electric vehicle electrically connected to the motor, it can be configured that the swing arm, the functional component of the electric vehicle, and so on are made a unit and are preassembled. Therefore, the swing arm provided with the motor can be attached to the vehicle body after connecting wiring between the motor and the functional component of the electric vehicle, and performance in assembling the motor and the functional component of the electric vehicle can be improved. Also, since the functional component of the electric vehicle is not arranged in the swing arm, the swinging weight of the swing arm can be lightened.

Therefore, in the electric vehicle including the swing arm supporting the motor, it is possible to provide the electric vehicle having excellent performance in assembling the swing arm including the motor and the functional component of the electric vehicle while suppressing the swing arm from becoming large in size and the mass of an unsprung portion from increasing.

### (Second Configuration)

In the electric vehicle according to the first configuration, the sub frame includes a base portion extending in a vertical direction, and the sub frame includes connection portions of at least two positions of the top and bottom of an upper connecting portion and a lower connecting portion connecting the base portion to the body frame.

According to this configuration, since the sub frame includes the base portion extending in the vertical direction, it is facilitated to support a functional component of the electric vehicle in a space formed by the base portion. Also, since the sub frame is supported by two positions of the top and bottom, the swing arm can be supported with rigidity.

### (Third Configuration)

In the electric vehicle according to the second configuration, at least one of the upper connecting portion and the lower connecting portion extends forward of the vehicle body from the base portion in a vehicle side view and is connected to the body frame.

According to this configuration, since at least one of the upper connecting portion and the lower connecting portion extends forward and is connected to the body frame, a space can be arranged between the base portion and the body frame, and it is facilitated to store the functional component of the electric vehicle in the space.

### (Fourth Configuration)

In the electric vehicle according to the third configuration, the upper connecting portion extends forward of the vehicle body from an upper portion of the base portion in a vehicle side view and is connected to the body frame, and the lower connecting portion extends forward of the vehicle body from a lower portion of the base portion in a vehicle side view and is connected to the body frame.

According to this configuration, since the upper connecting portion and the lower connecting portion extend forward and are connected to the body frame, a space can be arranged between the base portion and the body frame, and it is facilitated to store the functional component of the electric vehicle in the space.

### (Fifth Configuration)

In the electric vehicle according to any of the second to fourth configurations, the sub frame includes a left portion and a right portion, the left portion and the right portion include the base portions, the upper connecting portions, and the lower connecting portions corresponding to the left portion and the right portion respectively, and the sub frame includes at least one cross member connecting the left portion and the right portion to each other.

According to this configuration, a space in the left and right direction can be formed by allowing the sub frame to have a pair of left and right shapes, and it is facilitated to store the functional component of the electric vehicle in the space. Also, the strength of the sub frame can be further increased by the cross member.

### (Sixth Configuration)

In the electric vehicle according to the fifth configuration, the functional component of the electric vehicle is disposed between the left portion and the right portion, is positioned between the body frame and the base portion in a vehicle front and rear direction, and is positioned between the upper connecting portion and the lower connecting portion in a vertical direction.

According to this configuration, since the functional component of the electric vehicle is disposed within a space formed by the sub frame, the functional component of the electric vehicle can be supported by the sub frame with strength while allowing the layout of the functional component of the electric vehicle to be compact.

### (Seventh Configuration)

In the electric vehicle according to any one of the first to sixth configurations, the functional component of the electric vehicle is connected to the sub frame through a bracket.

According to this configuration, since the functional component of the electric vehicle is attached to the sub frame through the bracket, the degree of freedom in attaching the functional component of the electric vehicle can be increased.

### (Eighth Configuration)

In the electric vehicle according to any one of the second to sixth configurations, a cross member is provided, the upper end portion of the base portion being connected to the cross member, a terminal of the functional component of the electric vehicle is positioned in an upper portion, wiring connected to the terminal of the functional component of the electric vehicle is provided, and the wiring passes the upper or lower side of the cross member and is cabled to the motor.

According to this configuration, the cross member can be utilized as a guide for the wiring facilitating routing of the wiring.

### (Ninth Configuration)

In the electric vehicle according to any one of the first to eighth configurations, the functional component of the electric vehicle is a control member controlling the motor.

According to this configuration, it is possible to attach the swing arm provided with the motor to the vehicle body after connecting the wiring between the motor and the control member. Particularly, when the control member is a PCU controlling the motor, it is possible to connect the wiring extending from the PCU, thick, and liable to increase rigidity without being affected by the body frame, and performance in assembling the motor and the PCU can be improved.

### (Tenth Configuration)

In the electric vehicle according to any one of the second to sixth configurations or the eighth configuration, a cross member is provided, the upper end portion of the base portion being connected to the cross member, and the pivot portion is arranged between the cross member and the base portion.

According to this configuration, the swing arm can be supported by the sub frame while further improving the strength of the sub frame.

### REFERENCE SIGNS LIST

10 Electric vehicle
11 Body frame
12 Rear wheel (driving wheel)
13 Electric motor (motor)
16 Swing arm
28 Sub frame
29 Pivot shaft
32 PCU (functional component of electric vehicle, control member)
55 Upper cross pipe (cross member)
57 Pivot gusset
58 Lower cross pipe (cross member)
60 Left portion
61a Vertical pipe portion (base portion)
61b Lower connecting pipe portion (lower connecting portion)
63 Upper connecting stay portion (upper connecting portion)
65b Left surface portion (pivot portion)
71a Vertical pipe portion (base portion)
71b Lower pipe portion (lower connecting portion)
73 Upper connecting stay portion (upper connecting portion)
75b Right surface portion (pivot portion)
70 Right portion
55 Cross member
58 Cross member
81 Power terminal portion (terminal)
83 High voltage wiring (wiring)
84 High voltage wiring (wiring)
85 High voltage wiring (wiring)
90 Bracket
360 Left portion
361a Vertical pipe portion (base portion)
370 Right portion
371a Vertical pipe portion (base portion)
410 Electric vehicle
411 Body frame
412 Rear wheel (driving wheel)
413 Electric motor (motor)
416 Swing arm
428 Sub frame
429 Pivot shaft
432 PCU (functional component of electric vehicle, control member)

1. An electric vehicle, comprising:
a swing arm swingably supported by a vehicle body through a pivot shaft;
a motor arranged in the swing arm and driving a driving wheel; and
a functional component of the electric vehicle electrically connected to the motor, wherein
a sub frame is provided, the sub frame being separate from a body frame configuring the vehicle body and being attachable to the body frame,
the sub frame includes a pivot portion swingably supporting the swing arm, and
the functional component of the electric vehicle is supported by the sub frame.

2. The electric vehicle according to claim 1, wherein
the sub frame includes a base portion extending in a vertical direction, and
the sub frame includes connection portions of at least two positions of the top and bottom of an upper connecting portion and a lower connecting portion connecting the base portion to the body frame.

3. The electric vehicle according to claim 2, wherein
at least one of the upper connecting portion and the lower connecting portion extends forward of the vehicle body from the base portion in a vehicle side view and is connected to the body frame.

4. The electric vehicle according to claim 2, wherein
the upper connecting portion extends forward of the vehicle body from an upper portion of the base portion in a vehicle side view and is connected to the body frame, and
the lower connecting portion extends forward of the vehicle body from a lower portion of the base portion in a vehicle side view and is connected to the body frame.

5. The electric vehicle according to claim 2, wherein
the sub frame includes a left portion and a right portion,
the left portion and the right portion include the base portion, the upper connecting portion, and the lower connecting portion corresponding to the left portion and the right portion respectively, and
the sub frame includes at least one cross member connecting the left portion and the right portion to each other.

6. The electric vehicle according to claim 5, wherein
the functional component of the electric vehicle is disposed between the left portion and the right portion, is positioned between the body frame and the base portion in a vehicle front and rear direction, and is positioned between the upper connecting portion and the lower connecting portion in a vertical direction.

7. The electric vehicle according to claim 1, wherein
the functional component of the electric vehicle is connected to the sub frame through a bracket.

8. The electric vehicle according to claim 2, wherein
a cross member is provided, an upper end portion of the base portion being connected to the cross member,
a terminal of the functional component of the electric vehicle is positioned in an upper portion,
wiring connected to the terminal of the functional component of the electric vehicle is provided, and
the wiring passes the upper or lower side of the cross member and is cabled to the motor.

9. The electric vehicle according to claim 1, wherein
the functional component of the electric vehicle is a control member controlling the motor.

10. The electric vehicle according to claim 2, wherein
a cross member is provided, an upper end portion of the base portion being connected to the cross member, and
the pivot portion is arranged between the cross member and the base portion.
